(19) United States
(12) Patent Application Publication
(10) Pub. No.: US 2022/0393189 A1
(43) Pub. Date: Dec. 8, 2022

(54) AIR-COOLED FUEL CELL

(71) Applicant: TOYOTA JIDOSHA KABUSHIKI KAISHA, Toyota-shi (JP)

(72) Inventor: Nobuaki NONOYAMA, Chiryu- shi (JP)

(73) Assignee: TOYOTA JIDOSHA KABUSHIKI KAISHA, Toyota-shi (JP)

(21) Appl. No.: 17/804,708

(22) Filed: May 31, 2022

(30) Foreign Application Priority Data
Jun. 2, 2021 (JP) 2021-092785

(51) Int. Cl. H01M 8/026; H01M 8/04014; H01M 8/0267; H01M 8/1004

(52) U.S. Cl. CPC H01M 8/026; H01M 8/04014; H01M 8/0267; H01M 8/1004; H01M 2008/1095

(57) ABSTRACT

To provide an air-cooled fuel cell with increased durability and power generation performance. An air-cooled fuel cell wherein the air-cooled fuel cell includes a second separator, a membrane electrode gas diffusion layer assembly, a first separator and a cooling plate in this order; wherein a sum of a flow path width and rib width of third flow paths is larger than a sum of a flow path width and rib width of first flow paths and a sum of a flow path width and rib width of second flow paths; wherein, in a power generation region in which the first separator, the second separator and the cooling plate overlap with the membrane electrode gas diffusion layer assembly when viewed from above, part of the first flow paths, part of the second flow paths, and part of the third flow paths intersect with each other.

### TECHNICAL FIELD

The disclosure relates to an air-cooled fuel cell.

### BACKGROUND

A fuel cell (FC) is a power generation device which is composed of a single unit fuel cell (hereinafter, it may be referred to as “cell”) or a fuel cell stack composed of stacked unit fuel cells (hereinafter, it may be referred to as “stack”) and which generates electrical energy by electrochemical reaction between fuel gas (e.g., hydrogen) and oxidant gas (e.g., oxygen). In many cases, the fuel gas and oxidant gas actually supplied to the fuel cell, are mixtures with gases that do not contribute to oxidation and reduction. Especially, the oxidant gas is often air containing oxygen.

Hereinafter, fuel gas and oxidant gas may be collectively and simply referred to as “reaction gas” or “gas”. Also, a single unit fuel cell and a fuel cell stack composed of stacked unit cells may be referred to as “fuel cell”.

The unit fuel cell generally includes a membrane electrode assembly (MEA).

Various techniques relating to fuel cells mounted and used in fuel cell electric vehicles (hereinafter may be referred to as “vehicle”) were proposed.

For example, Patent Literature 1 discloses a solid polymer electrolyte fuel cell in which reaction gas can be supplied at a moderately fast flow rate without excessive load on the coolant supply system and which can be efficiently operated.

Patent Literature 2 discloses an electrode of a fuel cell, which is capable of quickly draining water accumulated in a diffusion layer and hardly breaking the diffusion layer.
Patent Literature 1: Japanese Patent Application Laid-Open (JP-A) No. 1998-308227
Patent Literature 2: JP-A No. 2007-299654

The gas flow path and refrigerant flow path of a fuel cell are composed of dimples or grooves formed on a separator. If separators, which should be stacked so that the convex portions of the dimples or grooves of the separators face each other, are stacked in a misaligned manner, shear force is applied to an electrolyte membrane and a gas diffusion layer, which are components sandwiched by them; a part with increased load and a part with reduced load are locally produced; and then a decrease in the performance of the fuel cell or a deterioration of the fuel cell is caused, accordingly.

A water-cooled fuel cell generally includes two separators on which flow paths are formed at a relatively narrow groove pitch. Accordingly, the above-mentioned problem is prevented by intersecting the flow paths. In an air-cooled fuel cell, however, in order to increase heat transfer and decrease pressure loss, a cooling air flow path is needed to be flow paths at a wide groove pitch, and the distance between convex portions facing each other increases. Accordingly, a region with reduced load tends to be large. The same applies to the case of a three-layered structure in which a cooling plate is provided in addition to the separators.

### SUMMARY

The present disclosure was achieved in light of the above circumstances. An object of the present disclosure is to provide an air-cooled fuel cell with increased durability and power generation performance.

The air-cooled fuel cell of the disclosed embodiments is an air-cooled fuel cell,

wherein the air-cooled fuel cell comprises a first separator, a second separator and a cooling plate;

wherein the first separator periodically includes first flow paths in a groove form;

wherein the second separator periodically includes second flow paths in a groove form;

the cooling plate periodically includes third flow paths in a groove form;

wherein the air-cooled fuel cell includes the second separator, a membrane electrode gas diffusion layer assembly, the first separator and the cooling plate in this order;

wherein a sum of a flow path width and rib width of the third flow paths is larger than a sum of a flow path width and rib width of the first flow paths and a sum of a flow path width and rib width of the second flow paths;

wherein, in a power generation region in which the first separator, the second separator and the cooling plate overlap with the membrane electrode gas diffusion layer assembly when viewed from above, part of the first flow paths, part of the second flow paths, and part of the third flow paths intersect with each other;

wherein an angle θ₁₂ between the first flow paths and the second flow paths is 15° or more; and

wherein an angle θ₁₃ between the first flow paths and the third flow paths and an angle θ₂₃ between the second flow paths and the third flow paths are 40° or more.

Ones of the first flow paths and the second flow paths may be wavy grooves.

According to the present disclosure, the air-cooled fuel cell with increased durability and power generation performance is provided.

### BRIEF DESCRIPTION OF THE DRAWINGS

In the accompanying drawings,

FIG. 1 is a graph showing a relationship between intersection angle and load reduction Φ, for the angle θ₁₂ between the first flow paths of the first separator and the second flow paths of the second separator, the angle θ₁₃ between the first flow paths of the first separator and the third flow paths of the cooling plate, and the angle θ₂₃ between the second flow paths of the second separator and the third flow paths of the cooling plate;

FIG. 2 is an exploded perspective view of an example of the unit fuel cell of the air-cooled fuel cell of the present disclosure;

FIG. 3 is a schematic view of the first, second and third flow paths of the fuel cell of Example 1, which are overlapped with each other;

FIG. 4 is a schematic view of the first and second separators of Example 1, which are overlapped with each other;

FIG. 5 is a schematic view of the first separator and cooling plate of Example 1, which are overlapped with each other; and

FIG. 6 is a schematic view of the second separator and cooling plate of Example 1, which are overlapped with each other.

### DETAILED DESCRIPTION

The air-cooled fuel cell of the disclosed embodiments is an air-cooled fuel cell,

wherein the air-cooled fuel cell comprises a first separator, a second separator and a cooling plate;

wherein the first separator periodically includes first flow paths in a groove form;

wherein the second separator periodically includes second flow paths in a groove form;

the cooling plate periodically includes third flow paths in a groove form;

wherein the air-cooled fuel cell includes the second separator, a membrane electrode gas diffusion layer assembly, the first separator and the cooling plate in this order;

wherein a sum of a flow path width and rib width of the third flow paths is larger than a sum of a flow path width and rib width of the first flow paths and a sum of a flow path width and rib width of the second flow paths;

wherein, in a power generation region in which the first separator, the second separator and the cooling plate overlap with the membrane electrode gas diffusion layer assembly when viewed from above, part of the first flow paths, part of the second flow paths, and part of the third flow paths intersect with each other;

wherein an angle θ₁₂ between the first flow paths and the second flow paths is 15° or more; and

wherein an angle θ₁₃ between the first flow paths and the third flow paths and an angle θ₂₃ between the second flow paths and the third flow paths are 40° or more.

If there is an interface where dimples or straight grooves overlap with each other in the flow path of a fuel cell, a change in ground contact area, a concentration of load, a reduction of load, or the like occurs in the interface when displacement occurs. Accordingly, a decrease in fuel cell performance, a deterioration of the fuel cell, or the like is caused.

A change in ground contact area affects the heat conduction, electrical resistance, load distribution and so on of the fuel cell.

For example, due to an increase in local load, a flow path is embedded in a gas diffusion layer (GDL). Accordingly, pressure loss increases and results in a decrease in fuel cell performance, or in the case of stacked unit fuel cells, a variation in performance between the unit fuel cells may occur. Due to a reduction of local load, a pressure applied to an electrolyte membrane is lost, and due to swelling and shrinking of the electrolyte membrane, the electrolyte membrane is moved and torn. In addition, due to a reduction of local load, the electrical resistance and heat conduction of the fuel cell deteriorate. As a result, a local heat spot is produced and accelerates a deterioration of the fuel cell.

A thick separator does not cause problems such as a change in ground contact area, a concentration of load, a reduction of load, and so on. However, the productivity of the separator is poor; the separator is heavy; and the cost of the separator is high.

In the case of a water-cooled fuel cell, the above-mentioned problems are problems with the flow paths of two separators. In the case of an air-cooled fuel cell, since the fuel cell has a three-layered structure composed of two separators and one cooling plate, it is needed to suppress the occurrence of a change in ground contact area, a concentration of load, a reduction of load and so on, in relation to the relationship between the flow paths of them.

According to the present disclosure, in the air-cooled fuel cell which includes a reaction air flow path, a fuel gas flow path and a cooling air flow path, the flow paths (grooves) are disposed so that they are not in parallel in the major region of a power generation unit. For example, the intersection angle between the reaction air flow path and the fuel gas flow path is set to a shallow angle; the intersection angle between the reaction air flow path and the cooling air flow path is set to a deeper angle; and the intersection angle between the fuel gas flow path and the cooling air flow path is set to a deeper angle.

According to the present disclosure, in the power generation region of the fuel cell, load applied to the electrolyte membrane, the gas diffusion layer and so on can be more uniform than before. Accordingly, damage to the electrolyte membrane, the gas diffusion layer and so on are reduced. As a result, the durability and power generation performance of the fuel cell are increased.

In the present disclosure, the fuel gas and the oxidant gas are collectively referred to as “reaction gas”. The reaction gas supplied to the anode is the fuel gas, and the reaction gas supplied to the cathode is the oxidant gas. The fuel gas is a gas mainly containing hydrogen, and it may be hydrogen. The oxidant gas may be oxygen, air, dry air or the like.

The fuel cell of the present disclosure is the air-cooled fuel cell.

The air-cooled fuel cell uses air as the refrigerant. In the present disclosure, air used as the refrigerant may be referred to as “cooling air”. Also in the present disclosure, air used as the oxidant gas may be referred to as “reaction air”.

The air-cooled fuel cell includes the first separator, the second separator and the cooling plate.

More specifically, the air-cooled fuel cell includes the second separator, the membrane electrode gas diffusion layer assembly, the first separator and the cooling plate in this order.

More specifically, the air-cooled fuel cell may be a single unit fuel cell which includes the second separator, the membrane electrode gas diffusion layer assembly, the first separator and the cooling plate in this order, or the air-cooled fuel cell may be a fuel cell stack composed of stacked unit fuel cells, each of which includes the second separator, the membrane electrode gas diffusion layer assembly, the first separator and the cooling plate in this order.

The membrane electrode gas diffusion layer assembly (MEGA) includes a first gas diffusion layer, a first catalyst layer, an electrolyte membrane, a second catalyst layer and a second gas diffusion layer in this order.

More specifically, the membrane electrode gas diffusion layer assembly includes an anode-side gas diffusion layer, an anode catalyst layer, an electrolyte membrane, a cathode catalyst layer and a cathode-side gas diffusion layer in this order.

One of the first and second catalyst layers is the cathode catalyst layer, and the other is the anode catalyst layer.

The cathode (oxidant electrode) includes the cathode catalyst layer and the cathode-side gas diffusion layer.

The anode (fuel electrode) includes the anode catalyst layer and the anode-side gas diffusion layer.

The first catalyst layer and the second catalyst layer are collectively referred to as “catalyst layer”. The cathode catalyst layer and the anode catalyst layer are collectively referred to as “catalyst layer”.

One of the first gas diffusion layer and the second gas diffusion layer is the cathode-side gas diffusion layer, and the other is the anode-side gas diffusion layer.

The first gas diffusion layer is the cathode-side gas diffusion layer when the first catalyst layer is the cathode catalyst layer. The first gas diffusion layer is the anode-side gas diffusion layer when the first catalyst layer is the anode catalyst layer.

The second gas diffusion layer is the cathode-side gas diffusion layer when the second catalyst layer is the cathode catalyst layer. The second gas diffusion layer is the anode-side gas diffusion layer when the second catalyst layer is the anode catalyst layer.

The first gas diffusion layer and the second gas diffusion layer are collectively referred to as “gas diffusion layer” or “diffusion layer”. The cathode-side gas diffusion layer and the anode-side gas diffusion layer are collectively referred to as “gas diffusion layer” or “diffusion layer”.

The gas diffusion layer may be a gas-permeable electroconductive member or the like.

As the electroconductive member, examples include, but are not limited to, a porous carbon material such as carbon cloth and carbon paper, and a porous metal material such as metal mesh and foam metal.

The air-cooled fuel cell may include a microporous layer (MPL) between the catalyst layer and the gas diffusion layer. The microporous layer may contain a mixture of a water repellent resin such as PTFE and an electroconductive material such as carbon black.

The electrolyte membrane may be a solid polymer electrolyte membrane. As the solid polymer electrolyte membrane, examples include, but are not limited to, a hydrocarbon electrolyte membrane and a fluorine electrolyte membrane such as a thin, moisture-containing perfluorosulfonic acid membrane. The electrolyte membrane may be a Nafion membrane (manufactured by DuPont Co., Ltd.), for example.

One of the first separator and the second separator is the cathode-side separator, and the other is the anode-side separator.

The first separator is the cathode-side separator when the first catalyst layer is the cathode catalyst layer. The first separator is the anode-side separator when the first catalyst layer is the anode catalyst layer.

The second separator is the cathode-side separator when the second catalyst layer is the cathode catalyst layer. The second separator is the anode-side separator when the second catalyst layer is the anode catalyst layer.

The first separator and the second separator are collectively referred to as “separator”. The anode-side separator and the cathode-side separator are collectively referred to as “separator”.

The membrane electrode gas diffusion layer assembly is sandwiched by the first separator and the second separator.

The separator may include manifolds such as supply and discharge holes for allowing the fluid such as the reaction gas and the refrigerant to flow in the stacking direction of the unit fuel cells. As the refrigerant, for example, cooling air may be used.

As the supply hole, examples include, but are not limited to, a fuel gas supply hole, an oxidant gas supply hole, and a refrigerant supply hole.

As the discharge hole, examples include, but are not limited to, a fuel gas discharge hole, an oxidant gas discharge hole, and a refrigerant discharge hole.

The separator may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed.

The separator may be a gas-impermeable electroconductive member or the like. As the electroconductive member, examples include, but are not limited to, a resin material such as thermosetting resin, thermoplastic resin and resin fiber, a carbon composite material obtained by press-molding a mixture containing a carbonaceous material such as carbon powder and carbon fiber, gas-impermeable dense carbon obtained by carbon densification, and a metal plate (such as a titanium plate, an iron plate, an aluminum plate and a stainless-steel (SUS) plate) obtained by press-molding. The separator may function as a collector.

The shape of the separator may be a rectangular shape, a horizontal hexagon shape, a horizontal octagon shape, a circular shape or a long circular shape, for example.

The first separator periodically includes the first flow paths in a groove form. More specifically, the first separator periodically includes grooves (flow paths) and ribs at a predetermined groove pitch, alternately.

The second separator periodically includes the second flow paths in a groove form. More specifically, the second separator periodically includes grooves (flow paths) and ribs at a predetermined groove pitch, alternately.

The groove pitch means the repeating unit of the sum of the groove width and the rib width. For example, the groove pitch may be from 1.0 mm to 1.8 mm, or it may be from 1.2 mm to 1.6 mm.

Ones of the first flow paths and the second flow paths may be wavy grooves, or both of the first flow paths and the second flow paths may be wavy grooves.

Ones of the first flow paths and the second flow paths may be straight grooves.

The separator may include a reaction gas flow path on a surface in contact with the gas diffusion layer. Also, the separator may include a refrigerant flow path for keeping the fuel cell temperature constant, on the surface opposite to the surface in contact with the gas diffusion layer. The first flow paths of the first separator may be ones of reaction gas flow paths and refrigerant flow paths, or the first flow paths may be reaction gas flow paths and refrigerant flow paths. The second flow paths of the second separator may be ones of reaction gas flow paths and refrigerant flow paths, or the second flow paths may be reaction gas flow paths and refrigerant flow paths.

The separator may include a gas divider. The gas divider is disposed in a region between the manifold and flow paths of the separator, and it spreads and unspreads a gas flow from the manifold to the power generation region. When the manifold is a supply hole, the gas divider has the structure of spreading the gas flow. When the manifold is a discharge hole, the gas divider has the structure of unspreading the gas flow.

When the separator is the anode-side separator, it may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed. The anode-side separator may include a fuel gas flow path for allowing the fuel gas to flow from the fuel gas supply hole to the fuel gas discharge hole, on the surface in contact with the anode-side gas diffusion layer. As needed, the anode-side separator may include a refrigerant flow path for allowing the refrigerant to from the refrigerant supply hole to the refrigerant discharge hole, on the surface opposite to the surface in contact with the anode-side gas diffusion layer.

When the separator is the cathode-side separator, it may include one or more fuel gas supply holes, one or more oxidant gas supply holes, one or more refrigerant supply holes as needed, one or more fuel gas discharge holes, one or more oxidant gas discharge holes, and one or more refrigerant discharge holes as needed. The cathode-side separator may include an oxidant gas flow path for allowing the oxidant gas to flow from the oxidant gas supply hole to the oxidant gas discharge hole, on the surface in contact with the cathode-side gas diffusion layer. As needed, the cathode-side separator may include a refrigerant flow path for allowing the refrigerant to flow from the refrigerant supply hole to the refrigerant discharge hole, on the surface opposite to the surface in contact with the cathode-side gas diffusion layer.

The cooling plate periodically includes the third flow paths in a groove form. More specifically, the cooling plate periodically includes grooves (flow paths) and ribs at a predetermined groove pitch, alternately.

The third flow paths may be wavy grooves, or they may be straight grooves.

The cooling plate may be a corrugated plate including grooves configured to function as a refrigerant flow path.

As the cooling plate, for example, a corrugated metal plate obtained by folding a metal plate (such as an aluminum plate, a Ti plate and an SUS plate) may be used. The surface of the cooling plate may be subjected to conductive treatment with silver, nickel, carbon or the like.

The grooves of the cooling plate may be formed by folding the cooling plate.

The depth of the grooves may be from 1.0 mm to 2.0 mm, for example.

The metal plate may be folded to form grooves with a depth of from 1.0 mm to 2.0 mm at a pitch of from 1.0 mm to 2.0 mm, for example, thereby preparing the corrugated cooling plate.

The cooling plate may be disposed in the region which faces at least the MEGA in the planar direction.

The cooling plate may be disposed in a region which is other than the region where the gasket is disposed between the unit fuel cells adjacent to each other in the planar direction.

The cooling plate may include a protrusion protruding from the unit fuel cell.

The shape of the cooling plate may be a rectangular shape, a horizontal hexagon shape, a horizontal octagon shape, a circular shape or a long circular shape, for example.

The sum of the flow path width and rib width of the third flow paths is larger than the sum of the flow path width and rib width of the first flow paths and the sum of the flow path width and rib width of the second flow paths.

In the power generation region in which the first separator, the second separator and the cooling plate overlap with the membrane electrode gas diffusion layer assembly when viewed from above, part of the first flow paths, part of the second flow paths, and part of the third flow paths intersect with each other. In the power generation region, part of the first flow paths, part of the second flow paths, and part of the third flow paths may intersect with each other. From the viewpoint of increasing the durability of the fuel cell, the first flow paths, the second flow paths, and the third flow paths may intersect with each other in the whole power generation region.

In a gas dividing region in which the gas divider of the separator is disposed and the first separator, the second separator and the cooling plate overlap with the gas divider when viewed from above, part of the first flow paths, part of the second flow paths, and part of the third flow paths may intersect with each other.

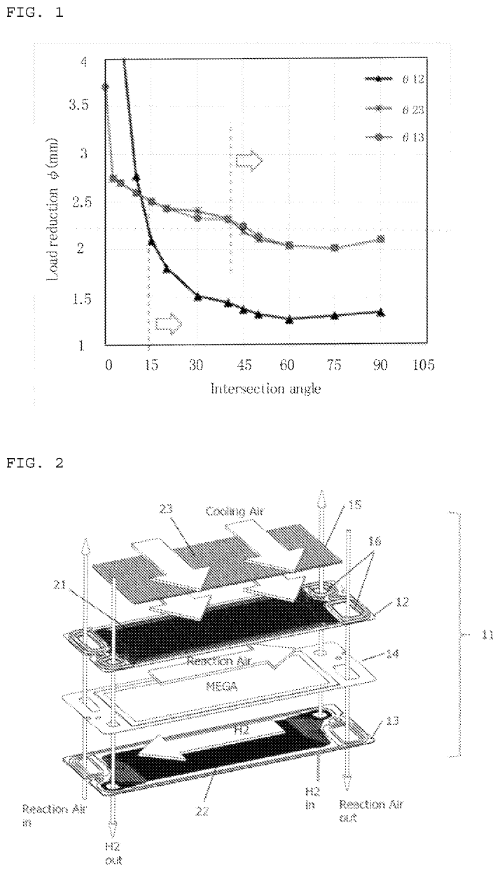

FIG. 1 is a graph showing a relationship between intersection angle and load reduction Φ, for the angle θ₁₂ between the first flow paths of the first separator and the second flow paths of the second separator, the angle θ₁₃ between the first flow paths of the first separator and the third flow paths of the cooling plate, and the angle θ₂₃ between the second flow paths of the second separator and the third flow paths of the cooling plate.

The angle θ₁₂ between the first flow paths of the first separator and the second flow paths of the second separator may be 15° or more. From the viewpoint of decreasing the load reduction Φ and increasing the durability of the fuel cell, the angle θ₁₂ may be 20° or more and 90° or less.

The angle θ₁₃ between the first flow paths of the first separator and the third flow paths of the cooling plate and the angle θ₂₃ between the second flow paths of the second separator and the third flow paths of the cooling plate, may be 40° or more. From the viewpoint of decreasing the load reduction Φ and increasing the durability of the fuel cell, the angle θ₁₃ and the angle θ₂₃ may be 50° or more and 90° or less.

The first flow paths, the second flow paths, and the third flow paths intersect with each other. Accordingly, when the first separator, the second separator, the cooling plate and the like are displaced, a change in ground contact area and a change in load are small, a variation in performance between the unit fuel cells is reduced, and the robustness of the fuel cell to the displacement is increased.

In the air-cooled fuel cell, for pressure loss reduction of the refrigerant flow paths, the refrigerant flow paths of the cooling plate are in a deeper and wider groove form, compared to the flow paths of the separator. Accordingly, the load reduction areas Φ₂₃ and Φ₁₃ are likely to be increased. As shown in FIG. 1, by deeply intersecting the θ₁₃ and the θ₂₃ at an angle of 40° or more, the load reduction areas are decreased.

The air-cooled fuel cell may include a resin frame.

The resin frame may be disposed in the periphery of the membrane electrode gas diffusion layer assembly and may be disposed between the first separator and the second separator.

The resin frame may be a component for preventing cross leakage or a short circuit between the catalyst layers of the membrane electrode gas diffusion layer assembly.

The resin frame may include a skeleton, an opening, supply holes and discharge holes.

The skeleton is a main part of the resin frame, and it connects to the membrane electrode gas diffusion layer assembly.

The opening is a region retaining the membrane electrode gas diffusion layer assembly, and it is also a through-hole penetrating a part of the skeleton to set the membrane electrode gas diffusion layer assembly therein. In the resin frame, the opening may be disposed in the position where the skeleton is disposed around (in the periphery) of the membrane electrode gas diffusion layer assembly, or it may be disposed in the center of the resin frame.

The supply and discharge holes allows the reaction gas, the refrigerant and the like to flow in the stacking direction of the unit fuel cells. The supply holes of the resin frame may be aligned and disposed to communicate with the supply holes of the separator. The discharge holes of the resin frame may be aligned and disposed to communicate with the discharge holes of the separator.

The resin frame may include a frame-shaped core layer and two frame-shaped shell layers disposed on both surfaces of the core layer, that is, a first shell layer and a second shell layer.

Like the core layer, the first shell layer and the second shell layer may be disposed in a frame shape on both surfaces of the core layer.

The core layer may be a structural member which has gas sealing properties and insulating properties. The core layer may be formed of a material such that the structure is unchanged at the temperature of hot pressing in a fuel cell production process. As the material for the core layer, examples include, but are not limited to, resins such as polyethylene, polypropylene, polycarbonate (PC), polyphenylene sulfide (PPS), polyethylene terephthalate (PET), polyethylene naphthalate (PEN), polyamide (PA), polyimide (PI), polystyrene (PS), polyphenylene ether (PPE), polyether ether ketone (PEEK), cycloolefin, polyethersulfone (PES), polyphenylsulfone (PPSU), liquid crystal polymer (LCP) and epoxy resin. The material for the core layer may be a rubber material such as ethylene propylene diene rubber (EPDM), fluorine-based rubber and silicon-based rubber.

From the viewpoint of ensuring insulating properties, the thickness of the core layer may be 5 μm or more, or it may be 30 μm or more. From the viewpoint of reducing the cell thickness, the thickness of the core layer may be 200 μm or less, or it may be 150 μm or less.

To attach the core layer to the anode-side and cathode-side separators and to ensure sealing properties, the first shell layer and the second shell layer may have the following properties: the first and second shell layers have high adhesion to other substances; they are softened at the temperature of hot pressing; and they have lower viscosity and lower melting point than the core layer. More specifically, the first shell layer and the second shell layer may be thermoplastic resin such as polyester-based resin and modified olefin-based resin, or they may be thermosetting resin such as modified epoxy resin. The first shell layer and the second shell layer may be the same kind of resin as the adhesive layer.

The resin for forming the first shell layer and the resin for forming the second shell layer may be the same kind of resin, or they may be different kinds of resins. By disposing the shell layers on both surfaces of the core layer, it becomes easy to attach the resin frame and the two separators by hot pressing.

From the viewpoint of ensuring adhesion, the thickness of the first and second shell layers may be 5 μm or more, or it may be 20 μm or more. From the viewpoint of reducing the cell thickness, the thickness of the first and second shall layers may be 100 μm or less, or it may be 40 μm or less.

In the resin frame, the first shell layer may be disposed only at a part that is attached to the anode-side separator, and the second shell layer may be disposed only at a part attached to the cathode-side separator. The first shell layer disposed on one surface of the core layer may be attached to the cathode-side separator. The second shell layer disposed on the other surface of the core layer may be attached to the anode-side separator. The resin frame may be sandwiched by the pair of separators.

The air-cooled fuel cell may include a gasket between the adjacent unit fuel cells.

The material for the gasket may be ethylene propylene diene monomer (EPDM) rubber, silicon rubber, thermoplastic elastomer resin or the like.

FIG. 2 is an exploded perspective view of an example of the unit fuel cell of the air-cooled fuel cell of the present disclosure.

The air-cooled fuel cell (unit fuel cell) 11 includes a cooling plate 15, a first separator 12, a resin frame 14 in which a MEGA is disposed in its opening, and a second separator 13 in this order.

The cooling plate 15 is disposed in a region which faces the MEGA on a surface of the first separator 12 of the air-cooled fuel cell 11.

In the first separator 12, the resin frame 14 and the second separator 13, an oxidant gas supply hole, an oxidant gas discharge hole, a fuel gas supply hole and a fuel gas discharge hole are disposed, all of which are manifolds 16 through which reaction air (oxidant gas) and hydrogen (fuel gas) can flow as indicated by arrows.

In the first separator 12, first flow paths 21 in a groove form are disposed, which serve as the oxidant gas flow path through which reaction air (oxidant) can flow as indicated by an arrow.

In the second separator 13, second flow paths 22 in a groove form are disposed, which serve as the fuel gas flow path through which hydrogen (fuel gas) can flow as indicated by an arrow.

In the cooling plate (cooling fin) 15, third flow paths 23 in a groove form are disposed, which serve as the refrigerant flow path through which cooling air (refrigerant) can flow as indicated by arrows.

The fuel cell may have a structure such that the refrigerant flows on the side surfaces thereof.

### EXAMPLES

### Example 1

Unit fuel cells were produced by use of the following first separator, second separator and cooling plate.
First separator: Straight grooves in longitudinal direction (first flow paths for reaction air, groove pitch 1.4 mm)
Second separator: Wavy grooves in longitudinal direction, inclined at an angle of 30° (second flow paths for hydrogen, groove pitch 1.5 mm)
Cooling plate: Straight grooves in lateral direction (third flow paths for cooling air, groove pitch 3 mm)

The angles θ₁₂, θ₁₃ and θ₂₃ were set to 30°, 90° and 60°, respectively.

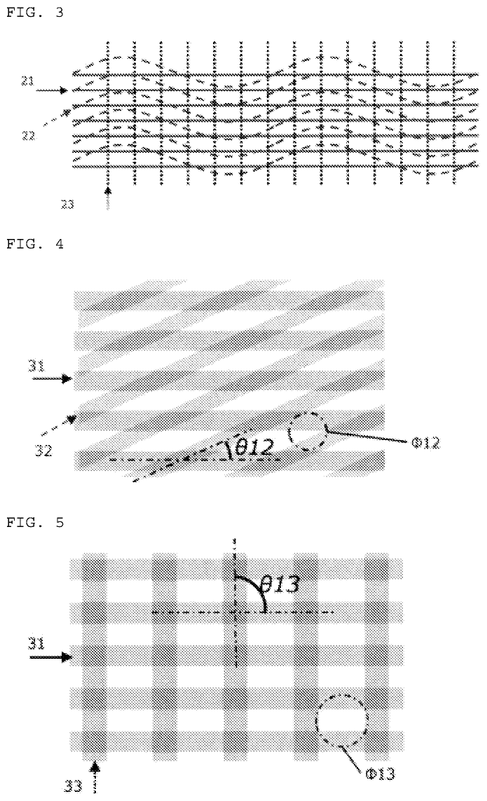

FIG. 3 is a schematic view of the first, second and third flow paths of the fuel cell of Example 1, which are overlapped with each other.

The first flow paths 21 are straight grooves in longitudinal direction.

The second flow paths 22 are wavy grooves in longitudinal direction.

The third flow paths 23 are straight grooves in lateral direction.

The first flow paths 21, the second flow paths 22 and the third flow paths 23 intersect with each other.

FIG. 4 is a schematic view of the first and second separators of Example 1, which are overlapped with each other.

As with the angle between the first flow paths and the second flow paths, the ribs 31 of the first separator and the ribs 32 of the second separator intersect at an angle θ₁₂ of 30°.

The Φ₁₂ is a reduction of load (load reduction) which occurs between the first separator and the second separator. For example, the region in which the ribs 31 of the first separator intersect with the ribs 32 of the second separator is a region in which the upper and lower surfaces of a MEGA are pressed to fix the MEGA. A one-side groove region in which the ribs 31 of the first separator do not intersect with the ribs 32 of the second separator or a both-side groove region, is a region in which the MEGA is not fixed, and the load reduction Φ₁₂ can be the diameter of the maximum circle which can be drawn in the region.

Compared to FIG. 1, the load reduction Φ when the angle θ₁₂ is 30°, is 2.3 mm or less; the distribution of load is uniform; and desired fuel cell durability is achieved.

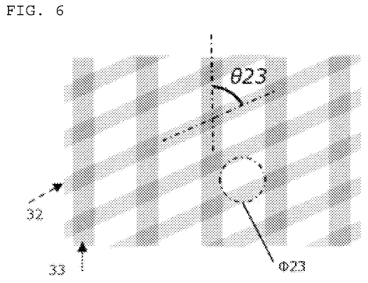

FIG. 5 is a schematic view of the first separator and cooling plate of Example 1, which are overlapped with each other.

As with the angle between the first flow paths and the third flow paths, the ribs 31 of the first separator and the ribs 33 of the cooling plate intersect at an angle θ₁₃ of 90°.

The Φ₁₃ is a reduction of load (load reduction) which occurs between the first separator and the cooling plate. The load reduction Φ₁₃ can be the diameter of the maximum circle which can be drawn in the one-side groove region in which the ribs 31 of the first separator do not intersect with the ribs 33 of the cooling plate or the both-side groove region.

Compared to FIG. 1, the load reduction Φ when the angle θ₁₃ is 90°, is 2.3 mm or less; the distribution of load is uniform; and desired fuel cell durability is achieved.

FIG. 6 is a schematic view of the second separator and cooling plate of Example 1, which are overlapped with each other.

As the angle between the second flow paths and the third flow paths, the ribs 32 of the second separator and the ribs 33 of the cooling plate intersect at an angle θ₂₃ of 60°.

The Φ₂₃ is a reduction of load (load reduction) which occurs between the second separator and the cooling plate. The load reduction Φ₂₃ can be the diameter of the maximum circle which can be drawn in the one-side groove region in which the ribs 32 of the second separator do not intersect with the ribs 33 of the cooling plate or the both-side groove region.

Compared to FIG. 1, the load reduction Φ when the angle θ₂₃ is 60°, is 2.3 mm or less; the distribution of load is uniform; and desired fuel cell durability is achieved.

When the load reduction Φ is 2.3 mm or less, the fuel cell is determined to have the desired durability. The durability of the fuel cell increases as the load reduction Φ decreases.

### REFERENCE SIGNS LIST

11. Air-cooled fuel cell (Unit fuel cell)
12. First separator
13. Second separator
14. Resin frame
15. Cooling plate
16. Manifold
21. First flow paths
22. Second flow paths
23. Third flow paths
31. Ribs of the first separator
32. Ribs of the second separator
33. Ribs of the cooling plate

1. An air-cooled fuel cell,
wherein the air-cooled fuel cell comprises a first separator, a second separator and a cooling plate;
wherein the first separator periodically includes first flow paths in a groove form;
wherein the second separator periodically includes second flow paths in a groove form;
the cooling plate periodically includes third flow paths in a groove form;
wherein the air-cooled fuel cell includes the second separator, a membrane electrode gas diffusion layer assembly, the first separator and the cooling plate in this order;
wherein a sum of a flow path width and rib width of the third flow paths is larger than a sum of a flow path width and rib width of the first flow paths and a sum of a flow path width and rib width of the second flow paths;
wherein, in a power generation region in which the first separator, the second separator and the cooling plate overlap with the membrane electrode gas diffusion layer assembly when viewed from above, part of the first flow paths, part of the second flow paths, and part of the third flow paths intersect with each other;
wherein an angle θ₁₂ between the first flow paths and the second flow paths is 15° or more; and
wherein an angle θ₁₃ between the first flow paths and the third flow paths and an angle θ₂₃ between the second flow paths and the third flow paths are 40° or more.

2. The air-cooled fuel cell according to claim 1, wherein ones of the first flow paths and the second flow paths are wavy grooves.
